(19) United States
(12) Patent Application Publication
(10) Pub. No.: US 2008/0174417 A1
(43) Pub. Date: Jul. 24, 2008

(54) DIGITAL DISPLAY TYPE VEHICLE GAUGE

(75) Inventor: Thomas A. Schubert, Cortland, IL (US)

Correspondence Address: DICKSTEIN SHAPIRO LLP, 1825 EYE STREET NW, Washington, DC, 20006-5403, US

(73) Assignee: Auto Meter Products, Inc., Sycamore, IL (US)

(21) Appl. No.: 12/017,751

(22) Filed: Jan. 22, 2008

Related U.S. Application Data
(60) Provisional application No. 60/881,181, filed on Jan. 19, 2007.

(51) Int. Cl. G09F 9/00

(52) U.S. Cl. 340/461

(57) ABSTRACT

Digital display type gauge for numerically displaying rapidly changing values, such as vehicle digital display type gauges for numerically displaying engine rotation speed or vehicle speed. Least significant digits of digital display are displayed according to predetermined ranges for rates of change of the respective digit.

### FIELD OF THE INVENTION

Embodiments of the invention relate generally to a digital display type gauge for numerically displaying rapidly changing values, and more particularly to a vehicle digital display type gauge for numerically displaying changing engine rotation speed or vehicle speed.

### BACKGROUND OF THE DISCLOSURE

Various types of digital display type vehicle gauges for numerically displaying values are known, including digital displays representing automotive performance elements such as, for example, engine revolutions, oil temperature, fuel pressure, and voltage. One of the major disadvantages of digital displays, such as LED (light-emitting diode) and LCD (liquid crystal display) displays, is the poor readability of their least significant digits during rapid changes in the displayed value. In other words, the digits being shown may change so quickly, e.g., more than four changes per second, that the operator cannot accurately comprehend the digits being displayed. This problem is especially prominent in tachometers and speedometers during moments of great acceleration. To make matters worse, a vehicle driver may be subject to multiple digital images from different gauges.

In some instances, manufacturers have chosen to retard the rate of impulse current reporting the particular value, e.g., engine rotation or vehicle speed, in order to control the rate of digital display fluctuations or changes. Such measures, however, contravene the ultimate purpose of the gauge: timely reporting of vehicular performance and/or operations.

### BRIEF DESCRIPTION OF THE DRAWINGS

FIG. 1 is a block diagram illustrating a non-limiting embodiment of a known digital display type tachometer.

FIG. 2 is a schematic illustrating a non-limiting embodiment of a known processing circuit.

FIG. 3 is a block diagram illustrating a non-limiting example of one system for implementing an embodiment of the invention.

FIG. 4 is a flow diagram illustrating a non-limiting example of one possible decision process for determining whether to halt one or more digits of a digital display-type vehicle gauge.

### DETAILED DESCRIPTION OF THE INVENTION

In the following description, reference is made to the accompanying drawings, which form a part hereof. The description is provided to set forth a best mode of the embodiments of the invention and to enable those of ordinary skill in the art to make and use them. The following disclosure provides non-limiting embodiments of particular aspects of the invention, which are described with reference to an automobile. Structural, logical, procedural changes and the like may be made to the specific embodiments without departing from the spirit and scope of the invention.

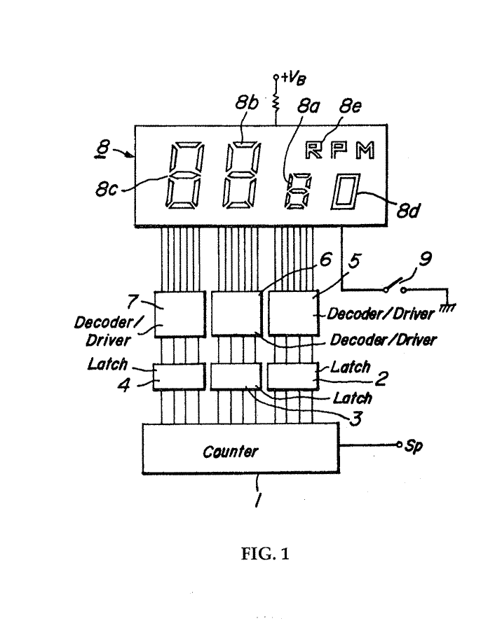

FIG. 1 is a block diagram illustrating a non-limiting example of a known digital display type tachometer. In this example, a counter 1 counts the number of angle pulses Sp per unit time, which pulses are generated from and based on a rotation speed of the engine, to produce BCD (Binary Coded Decimal) signals of 1000's, 100's, and 10's digits depending on the rotation speed of the engine.

The BCD signals are then latched by latch circuits 2, 3 and 4 at a predetermined timing respectively and converted into decimal character signals by decoder/driver circuits 5, 6 and 7 which character signals in turn are applied to a digital display device 8 having display sections 8a, 8b and 8c for the 1000's, 100's and 10's digits, each comprising seven segments to numerically display the rotation speed of the engine. A display section 8d for the 1's digit is constructed to display always “zero” and is driven together with a display section 8e for “RPM” by closing an ignition switch 9.

Even slight variations of the engine rotation speed in driving an automobile would cause the 10s digit display section (8a) to vary unsteadily and frequently. Thus, especially during times of intense acceleration, the driver would not be able to determine the value of the 10's digit (8a). Accordingly, the present invention implements a process by which a tachometer, speedometer, or other type of vehicle gauge maintains the respective rate of display of one or more digits according to predetermined thresholds or ranges (i.e., minimum and maximum acceptable rate of changes). These parameters may establish the same or different thresholds or ranges for the display rates of respective digital numeric position.

For example, if the rate of change increases for the tens digit, then the numerical display of that digit may be ceased or locked on its current value or a preset value until the rate of change falls within an acceptable range. Conversely, should the tachometer be showing only the thousands and hundreds digits and the rate of revolutions begins to decrease, the tens digit would become visible or “unlocked” as the input pulse reports a rate of change within the predetermined acceptable ranges for the respective digits. The same approach may be respectively applied to any digital position in the readout, such as, for example the tenths, ones, tens, hundreds, or even thousands digits, etc. The range of acceptable rates of change may vary in accordance with the particular numerical placement.

FIG. 1 is provided to merely illustrate one possible implementation of a digital display. There are, however, numerous possible implementations for carrying out aspects of this embodiment of the present invention. It should be noted that FIG. 1 of this application is a prior art design taken from FIG. 1 of U.S. Pat. No. 4,352,062 to Nomura. Differences between the teaching's of that reference (including the teachings that may be applied by Nomura to FIG. 1) and the teachings of this disclosure will be readily apparent to those skilled in the art.

Because of the prevalent use of software for automobile display systems, the algorithm can be implemented via numerous software code implementations well known in the art. However, for illustrative purposes, a non-limiting example of a possible processing circuit for a hardware implementation is provided below.

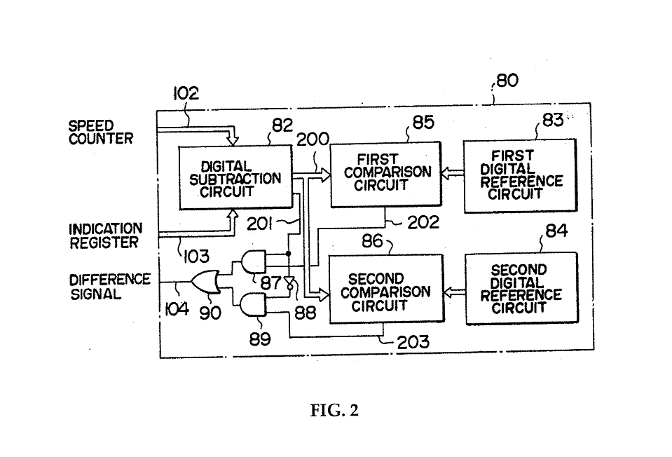

FIG. 2 is block diagram illustrating a processing circuit 80. The processing circuit 80 comprises: a digital subtraction circuit 82 for calculating a difference between the actual value of the engine revolution speed, e.g. as may be provided by a revolution speed counter known in the art, and the displayed value; a first digital reference circuit 83 for digitally presetting a positive hysteresis reference value, e.g., +10 rpm; a second digital reference circuit 84 for digitally presetting a negative hysteresis reference value, e.g., −10 rpm; a first comparison circuit 85 for emitting an output signal 202 based on an output 200 of the result of subtraction of the digital subtraction circuit 82 exceeding the positive reference value of the first digital reference circuit 83; a second comparison circuit 86 for emitting an output signal 203 also based on the output 200 of the result of subtraction of the digital subtraction circuit 82 exceeding the negative reference value of the reference circuit 84; a first AND gate 87 receiving a positive-negative sign signal 201 indicating “1” to a positive sign and “0” to a negative sign of the result of subtraction of the digital subtraction circuit 82 when the result of subtraction is positive so as to pass an output signal 202 from the first comparison circuit 85; a second AND gate 89 receiving positive-negative sign signal 201, inverted by an inverter 88, when the result of subtraction is negative so as to pass an output signal 203 from the second comparison circuit 86; and an OR gate 90 for emitting a logical sum of the first AND gate 87 and the second AND gate 89 as the difference signal 104.

The processing circuit 80 is thus adapted to detect a difference between the actual value of the engine revolution speed and the displayed value. More particularly, in this example, when either the first AND gate 87 or the second AND gate 89 emits an output, the OR gate 90 is adapted to indicate the difference signal 104 as “1”. The difference signal can be used to indicate that a particular digit should be “frozen” at the displayed value, “blacked out” or “set” to a predetermined value (e.g. 0) in order to minimize distractions that would otherwise result from the rapid changing of that particular digit. For instance, if sudden acceleration causes the engine revolution speed to increase by greater than 10 rpm over the period of ¼ second, then the processing circuit 80 would output a signal “1” indicating that the tens digit should be frozen, blacked out, or set.

Those skilled in the art will appreciate that the above non-limiting example is merely one possible hardware implementation for halting (e.g., freezing, blacking out, or setting to zero) a particular digit of a digital-type display; and appreciate that processing can be implemented in software or other hardware configurations known in the art. Such “halting” may also be performed for more than one digit, e.g., the tens and hundreds digits.

In the above example, the output of the processing circuit 80 indicates whether the tens digit of the display will change in a span of less than ¼ second, which may be the shortest duration required for an average person to comprehend a newly displayed value. This required duration may vary in accordance with a particular individual or desired setting. Therefore, this embodiment may implement a design by which an individual variably sets the rate of change that triggers the halting of a particular digit; and by which the variably set rate of change may be different for respective digits. However, the rate of change may be permanently or otherwise preset into the device; and may be the same for all digits. Those skilled in the art will appreciate that such features can be easily added to a particular software or hardware implementation.

FIG. 2 is provided to merely illustrate one possible implementation for determining whether the rate of change for a digital display falls within a particular threshold. As stated above, there are numerous possible implementations for carrying out aspects of the embodiments of the present invention. It should be noted that FIG. 2 of this application is a prior art design taken from FIG. 5 of U.S. Pat. No. 4,368,426 to Hayashi et al. Differences between the teachings of that reference (including teachings that may be applied by Hayashi to FIG. 5) and the teachings of this disclosure will be readily apparent to those skilled in the art. For instance, Hayashi rewrites a value within an indication register if the processing circuit 80 determines that a rate of change (for speed) is greater than a particular value (e.g., plus or minus 1 km/h). In the above embodiment, a value is rewritten if the processing circuit 80 determines that a rate of change (for engine revolution speed) is less than a particular value (e.g., plus or minus 10 rpm for a ¼ second).

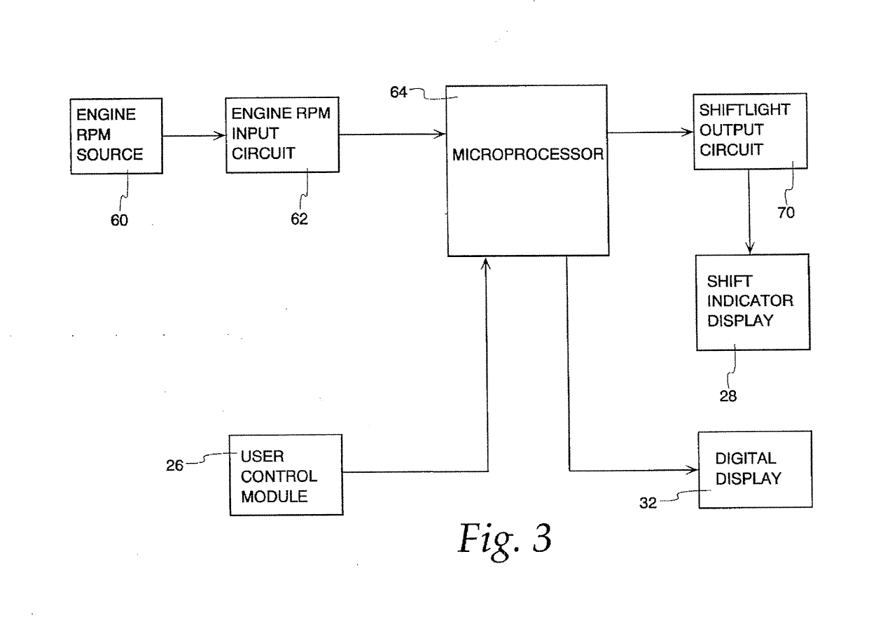

FIG. 3 is a block diagram illustrating a non-limiting example of a one possible system, in general terms, for implementing the above embodiment. As shown, a source of an engine RPM signal corresponding to the engine speed (RPM) is designated generally by the reference numeral 60. This source 60 may be an available source such as a sensor on the crankshaft of the engine (crank trigger), a low voltage or primary side of an ignition, or a tachometer output from an electronic transmission. A signal output of the signal source 60 corresponds generally to the engine speed (RPM) and is conditioned at engine RPM input circuitry 62 to a form useable by a controller 64. The controller 64 may comprise a microprocessor or microcontroller. The RPM input circuitry 62 may include noise filtering, signal level adjustment and isolation between the source 60 and the controller 64.

The variable setting of the display rate may be input to the controller from the user control module 26, which may in turn process this user setting information to accordingly control the display 32. The control module 26 may include or employ a combination of hardware and software, e.g., employ software to control the display 32 in accord with the signal output by the processor 80. As noted, however, a full software implementation or full hardware implementation could be easily created by those skilled in the art.

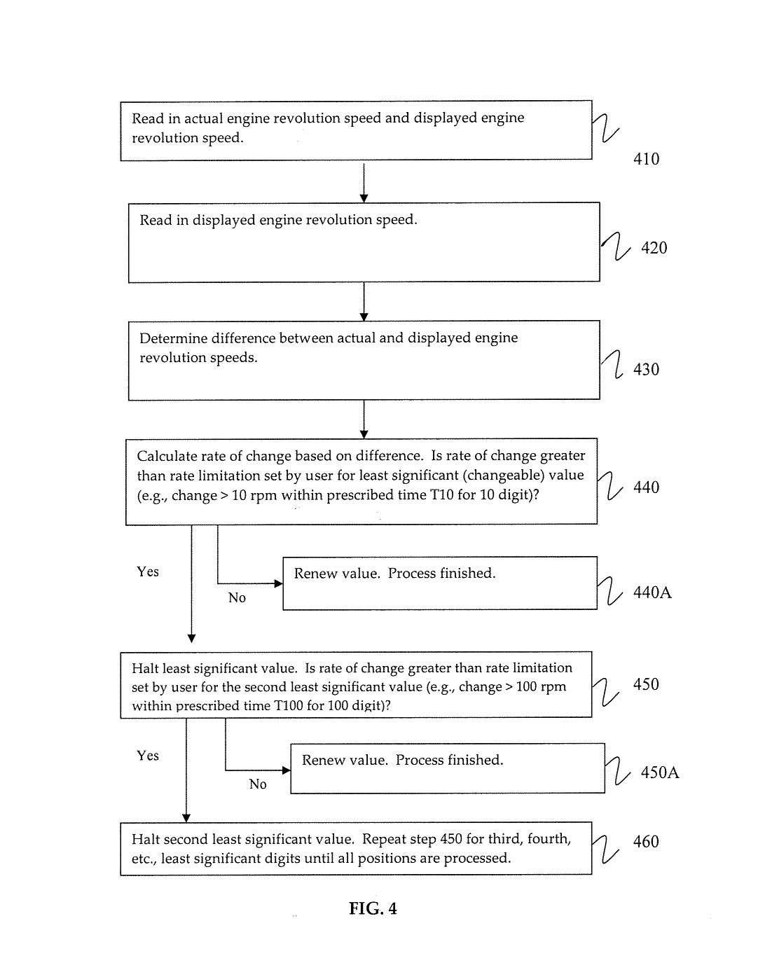

FIG. 4 is a flow diagram illustrating a non-limiting example of one possible decision process for determining whether to halt one or more digits of a digital display-type vehicle gauge. As shown, the process begins by reading in the actual speed, e.g., actual engine revolution speed, and the displayed speed, e.g., displayed engine revolution speed, in steps 410 and 420, respectively. The difference between the actual and displayed speeds is determined in step 430.

In step 440, the rate of change in speed, as determined based on the difference between the actual and displayed speeds, is calculated for the least significant digit. For instance, if the driver has set the device such that the tens digit is the least significant digit (i.e., if the ones digit is never changed) and such that it cannot be changed at a rate greater than ¼ second, then the device may determine, every ¼ second, whether the difference between the actual and displayed speeds is greater than 10. If that is the case, then the rate is exceeded.

If the rate of change is not exceeded, then the least significant digit is renewed and process ended at step 440A. However, if the rate of change is exceeded, then the process proceeds to step 450 where the least significant digit is halted; and where the it is determined whether the rate of change is exceeded for the second least significant digit. For instance, if the driver has set the device such that the hundred digit also cannot be changed at a rate greater than ¼ second, then the device may determine, every ¼ second, whether the difference between the actual and displayed speeds is greater than 100. If the rate is not exceeded, then the second least significant digit is renewed and the process is halted at step 450A. If that is the case, i.e., the rate is exceeded, then the second least significant digit is halted and the process is continued for the remaining positions at step 460.

While the embodiments have been described in detail in connection with preferred embodiments known at the time, it should be readily understood that the invention is not limited to the disclosed embodiments. Rather, the embodiments can be modified to incorporate any number of variations, alterations, substitutions, or equivalent arrangements not heretofore described, but which are commensurate with the spirit and scope of the invention. For example, while the embodiments are described in connection with a tachometer, they can be practiced with any other type of vehicle gauge, such as a speedometer.

What is claimed is:

1. A device for controlling a display, comprising:
a controller configured to compare a first value associated with an input signal to a second value associated with a display signal, to determine whether a difference between said first and second values exceeds a first predetermined value, and, when said difference exceeds said first predetermined value, to control said display to achieve one of (i) preventing at least a portion of said second value from displaying on said display and (ii) preventing at least a portion of said second value from changing on said display.

2. The device of claim 1, wherein said device comprises at least one of a vehicle tachometer and speedometer.

3. The device of claim 1, wherein said portion of said second value comprises a decimal digit.

4. The device of claim 3, wherein said display comprises a 7-segment LED device for displaying said decimal digit, and said LED device is refreshed at less than or equal to about four times per second.

5. The device of claim 1, further comprising said display.

6. The device of claim 3, wherein said at least a portion of said second value comprises at least one decimal digit of said second value when said difference exceeds said first predetermined value, and said at least a portion of said second value further comprises at least two a second decimal digit of said second value when said difference exceeds a second predetermined value greater than said first predetermined value.

7. The device of claim 1, wherein said display is refreshed at an adjustable refresh rate, and said first predetermined value is based on said refresh rate.

8. A method for controlling a display, comprising:
comparing a first value associated with an input signal to a second value associated with a display signal;
determining whether a difference between said first and second values exceeds a predetermined value; and
when said difference exceeds said first predetermined value, controlling said display to achieve one of (i) preventing at least a portion of said second value from displaying on said display and (ii) preventing at least a portion of said second value from changing on said display.

9. The method of claim 8, further comprising:
displaying said second value on at least one of a vehicle tachometer or speedometer.

10. The method of claim 8, wherein said portion of said second value comprises a decimal digit.

11. The method of claim 8, wherein said display comprises a 7-segment LED device for displaying said decimal digit, and said LED device is refreshed at less than or equal to about four times per second.

12. The method of claim 8, wherein said at least a portion of said second value comprises at least one decimal digit of said second value when said difference exceeds said first predetermined value, and said at least a portion of said display further comprises at least a second decimal digit of said second value when said difference exceeds a second predetermined value greater than said first predetermined value.

13. The method of claim 9, further comprising:
refreshing said display at an adjustable refresh rate; and
determining said first predetermined value based on said refresh rate.

14. A display system, comprising:
a gauge configured to output a first signal indicating a detected value;
a display configured to receive a second signal indicating a display value;
a comparator configured to compare said detected value and said display value, and to determine whether a difference between said detected value and said display value exceed a predetermined value; and
a controller configured to control said display, when said difference exceeds said predetermined value, to achieve one of (i) preventing at least a portion of said display value from displaying on said display and (ii) preventing at least a portion of said display value from changing on said display.

15. The system of claim 14, further comprising at least one of a tachometer and speedometer.

16. The system of claim 14, wherein said at least a portion of said display value comprises a decimal digit of said display value.

17. The system of claim 16, wherein said decimal digit of said display value is refreshed on said display at a refresh rate of less than or equal to 4 times per second.

18. The system of claim 14, further comprising:
a user interface configured to select an adjustable refresh rate for refreshing at least one decimal digit of said display value on said display by controlling said predetermined value.
